(19) United States
(12) Patent Application Publication
(10) Pub. No.: US 2012/0227008 A1
(43) Pub. Date: Sep. 6, 2012

(54) System and Method for Receiving Batch Input

(76) Inventor: Richard B. Himmelstein, Wilmington, NC (US)

(21) Appl. No.: 13/225,388

(22) Filed: Sep. 2, 2011

Related U.S. Application Data
(60) Provisional application No. 61/379,820, filed on Sep. 3, 2010.

(51) Int. Cl. G06F 3/048

(52) U.S. Cl. 715/780; 715/808

(57) ABSTRACT

A system and method for receiving contact information is disclosed. According to one example method, an administrative window is employed to define the input mode and a pop-up form is employed to receive input from a user.

### CROSS REFERENCE TO RELATED APPLICATION

This application claims priority from U.S. Provisional Application No. 61/379,820 filed Sep. 3, 2010 which is incorporated by reference as if fully set forth herein.

### TECHNICAL FIELD

The present application generally relates to systems, devices and methods for receiving data. More specifically, the present application relates to an applet for receiving user data input individually or as a batch.

### BACKGROUND

Social networking applications use data associated with individual users. Typically, a social networking application will provide a mechanism for receiving data directly from a user. For example, a typical social networking application may provide a form via a web site or an applet run on a client device for receiving data from the user.

Social networking applications are designed to accept data from each user individually, in a distributed fashion. If more than one user, such as members of a household, wishes to provide data to a social networking application, the mechanism for receiving data, such as an applet or HTML form, must be restarted before each user inputs his/her data. This process is inefficient, time consuming and frustrating for users entering their data. Accordingly, there is a need for a system, device and method for receiving registration data input in a batch.

### BRIEF DESCRIPTION OF THE DRAWINGS

The accompanying figures, which are incorporated in and constitute a part of the specification, illustrate various example apparatuses, systems, methods, and so on, and are used merely to illustrate various example embodiments. It should be noted that various components depicted in the figures may not be drawn to scale, and that the various assemblies and designs depicted in the figures are presented for purposes of illustration only, and should not be considered in any way as limiting.

FIG. 1 illustrates an example pop-up form for receiving data input from a single user.

FIG. 2 illustrates an administrative window to control the functionality of the example form of FIG. 1.

FIG. 3 illustrates an example pop-up form for receiving data input from one or more users.

### DETAILED DESCRIPTION

The present application describes systems, devices and methods for receiving input data from multiple users in a batch. Such systems, devices and methods may be used to efficiently receive input data by a social network or other application employing user data. In one example embodiment, the system, and devices and methods may utilize a web site accessible over the Internet. This allows the organization/institution to easily and efficiently to obtain/collect contact information from its members/subscribers. One benefit is that it avoids duplication of effort by users. Another benefit is that it ensures data accuracy by reusing previously entered data/information.

The systems, devices and methods described herein are designed to assist users in inputting data, such as registration data or contact information, for various organizations and/or institutions.

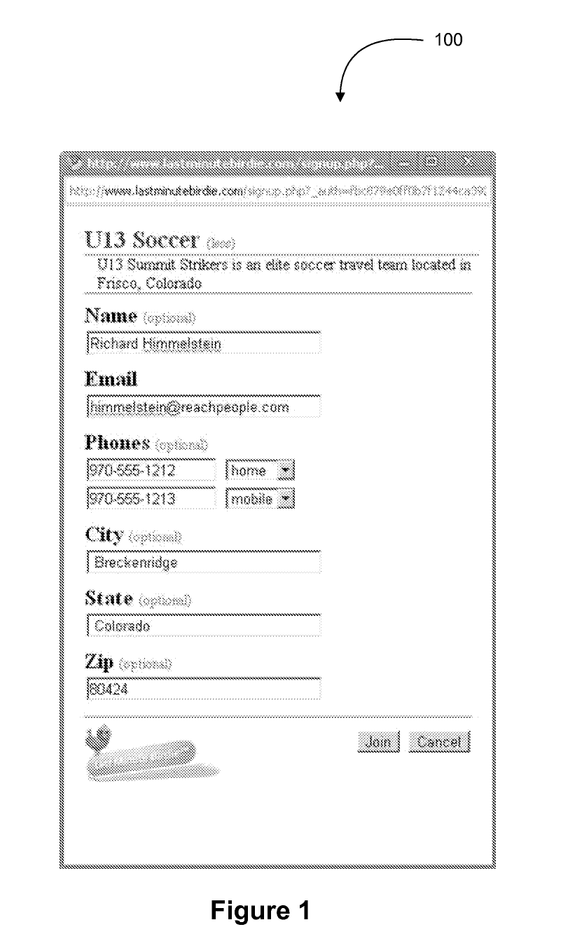

FIG. 1 illustrates an example pop-up form 100 for receiving user input. As illustrated, the form comprises fields for name, e-mail address, telephone numbers, city, state and zip code. One of ordinary skill in the art will recognize that such a form may comprise other fields as well as those depicted in FIG. 1. Such other fields may comprise, for example, address, birthday, likes, dislikes, and specific fields to select for filtering a user's interest in certain products. The example pop-up form may be generated by code embedded in a web page (“link”) or e-mail message. Further, it may be generated by an applet or application residing on a client device. The data input via the pop-up form may be stored on the client device and/or uploaded to a server at a later time. Of course, the applet or application may be downloaded from a server. The server may be connected to a global network of computers such as the Internet.

Example pop-up form 100 is intended to be used to input the data for a single user. Once the data is entered, the user may press the “Join” or “Cancel” button.

The “Join” button causes the pop-up form to transmit the data input via the pop-up form to a server for storage. Alternatively, the pop-up form may cause the data input via the pop-up form to be stored on the client device. In some embodiments, the data may be stored both at the server and at the client device. For example, once data has been entered on the client device, a cookie on the client device may retain the information. The information stored by the cookie may be reused at any time should the user of the client device select/click another link. The link could be for the same organization/institution, enabling the user to update information, or for a new organization/institution, enabling the user to provide the information without reentering it.

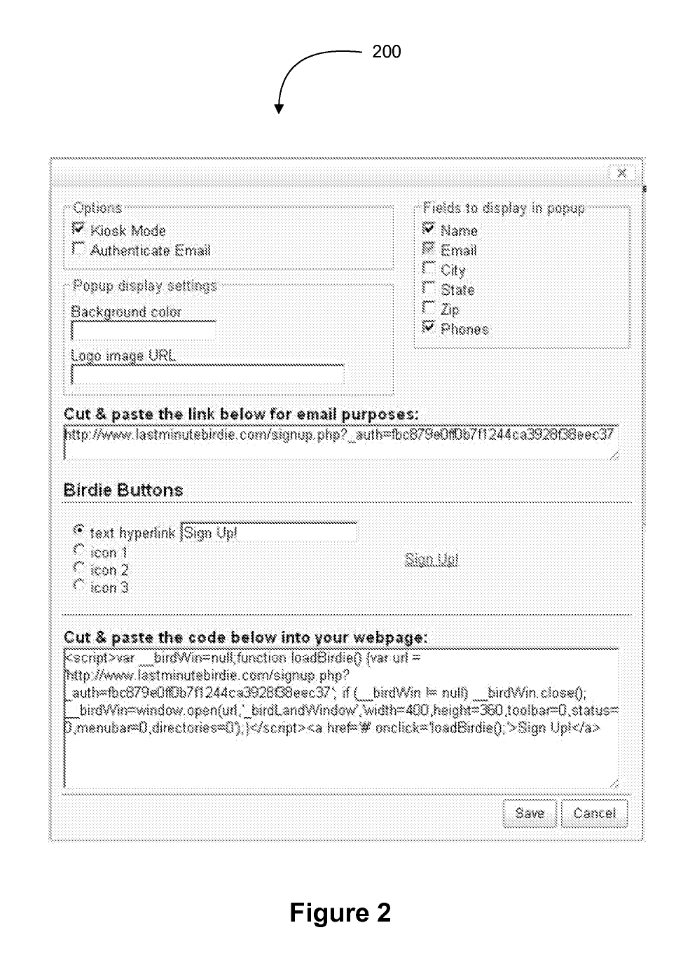

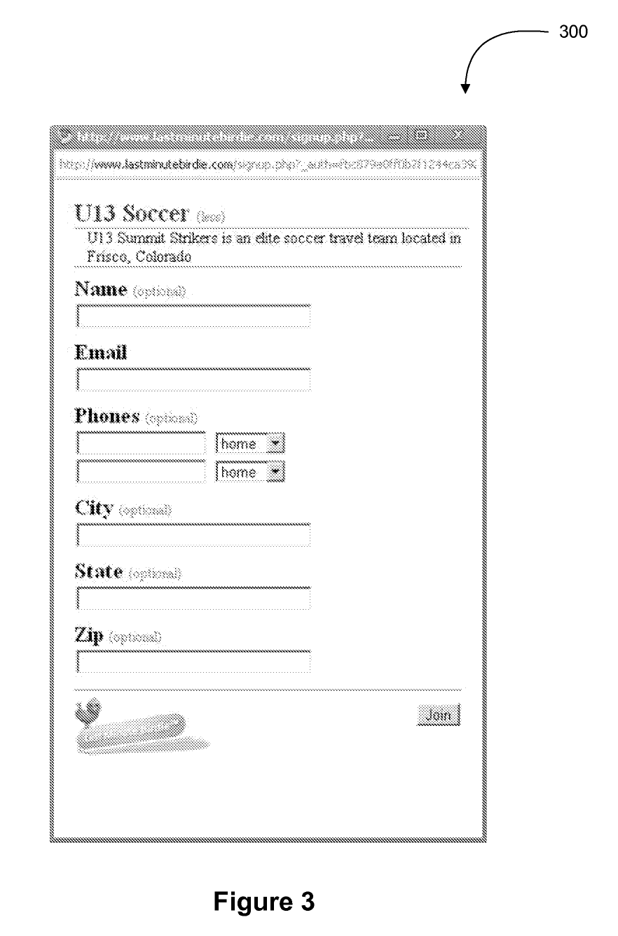

The administrative window 200 illustrated in FIG. 2, enables a system administrator to select the operating mode of the pop-up form. In the illustrated example, the pop-up form can be configured to operate in either of two operating modes: Kiosk mode or Authenticate e-mail mode. When operating in “Kiosk Mode” as described with respect to FIGS. 2 and 3 below, the pop-up window may clear the contents of the displayed fields upon selecting “Join” to enable another user to enter data. In this way, a plurality of users may use a single pop-up form on a single client device to input data. The pop-up form 300 operating in “Kiosk Mode” eliminates the need for subsequent users to re-open the pop-up form 100 thereby providing improved efficiency and less confusion.

The “Cancel” button enables a user to stop the registration process with a particular organization/institution. Alternatively, “Clear” button (not shown) could enable a user to clear the contents of the displayed fields without saving the data previously input into the fields. In this way, a user who changes his/her mind about providing data may clear any data and either re-enter data or close the pop-up form.

FIG. 2 illustrates an example administrative window 200 for controlling the functionality of the pop-up form of FIG. 1. Changes made in the administrative window 200 can take effect in real time. The example administrative window 200 may comprise one or more of the following: a check box for “Kiosk Mode,” a check box “Authenticate Email,” check boxes for defining fields to be displayed on pop-up form 100 or 300, pop-up display settings to define, for example, the background color and logo image to be displayed on pop-up form 100 or 300, hypertext options enabling the pop-up form to be sent and opened via an e-mail message, and custom HTML code which may be placed on a web page so that a link can be executed to open pop-up form 100 or 300.

In one embodiment, selecting “Authenticate Email” directs the pop-up form to send a confirmation e-mail to users during the joining process. The confirmation e-mail directs the user to select a link in the confirmation e-mail before becoming a member of the organization/institution, group or subgroup.

Using the Background color and Logo image URL, the system administrator may customize the appearance of the pop-up form to be consistent with any branding program that the system administrator desires to adhere to, such as conforming to a marketing or branding policy of an organization or institution. In another example embodiment, the system administrator could upload a logo to be used by the pop-up form.

The check box for “Kiosk Mode” controls whether the pop-up form collects information from a plurality of users, like pop-up-form 300 described below, or whether the pop-up form collects information from a single user, like pop-up form 100. In “Kiosk Mode,” the displayed pop-up form enables a user to input the requested data. Once the data is entered, the user may press the “Join” button. After the user receives a message that he has joined the group, the pop-up form is cleared of any data, and is ready for use by another user.

Although not shown, in one embodiment the system administrator may use a management console or administrative window to create customizable fields to be included in the pop-up. Examples include, but are not limited to, street address, likes, dislikes, and membership in a particular group, school or community. One advantage of providing customized fields is that the system administrator can determine into which sublist a user belongs. This allows the system administrator categorize users and to send communications to specific categories or groups of users. Contact methods may include e-mail, SMS text, voice message, and fax.

The check boxes labeled “Fields to display in pop-up” enables a system administrator to identify the fields of data to be collected by the pop-up form. As illustrated, administrative window 200 illustrates all check boxes selected, however the system administrator may uncheck any/all boxes for fields that the system administrator does not wish to be collected.

As illustrated, a link may be provided for use with an e-mail notification. When embedded in an e-mail message, the link is operative to open pop-up form 100 or 300. Further, the system administrator may select the appearance of the logo to be displayed on the pop-up form. This logo may be used to conform to a marketing or branding policy of an organization or institution.

At the bottom of administrative window 200, the system administrator may provide HTML or other code for use in the web page of the company or organization using the pop-up form to register users (e.g., obtain contact information). Upon the link/icon/code being selected or clicked, the pop-up form is displayed. This code is automatically generated in real time based upon what “Birdie Button,” text hyperlink or icon is to be provided.

FIG. 3 illustrates an example pop-up form 300 operating in a “Kiosk Mode,” where the “Kiosk Mode” check box of administrative window 200 is checked. Pop-up form 300 appears substantially similar to pop-up form 100, but does not provide the “Cancel” button.

Although not shown, pop-up forms 100 and 300 may be used to associate users with attributes, groups and/or subgroups of an institution/organization. Further, pop-up forms 100 and 300 may include terms and conditions associated with an institution/organization, such as a liability waiver for example.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the devices, systems, methods, and so on have been illustrated by describing examples, and while the examples have been described in considerable detail, it is not the intention of the applicant to restrict, or in any way, limit the scope of the appended claims to such detail. It is, of course, not possible to describe every conceivable combination of components or methodologies for purposes of describing the devices, systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

What is claimed is:

1. A method for receiving contact information, comprising:
displaying an administrative window for controlling the functionality of a pop-up form, the administrative window comprising mode options Rob, can you make the spec spell out mode options better?;
displaying the pop-up form to a user;
receiving input from the user via the pop-up form; and
processing the input based on the mode options of the administrative window.

2. The method of claim 1 wherein the administrative window further comprises pop-up display settings.

3. The method of claim 1 wherein the administrative window further comprises pop-up fields to display.

4. The method of claim 1 wherein the administrative window further comprises a field for receiving a customized e-mail link.

5. The method of claim 1 wherein the administrative window further comprises a plurality of button selections.

6. The method of claim 1 wherein the administrative window further comprises a field for receiving HTML code.

7. The method of claim 1 wherein the mode options comprise a kiosk mode.

8. The method of claim 1 wherein the mode options comprise an authenticate email mode.
